(19) United States
(12) Patent Application Publication
(10) Pub. No.: US 2010/0312972 A1
(43) Pub. Date: Dec. 9, 2010

(54) METHOD, APPARATUS AND SYSTEM FOR ENABLING PROCESSOR TO ACCESS SHARED DATA

(75) Inventor: Qiuming Gao, Shenzhen (CN)

Correspondence Address: Docket Clerk/HTCL, P.O. Drawer 800889, Dallas, TX, 75380, US

(73) Assignee: Huawei Technologies Co., Ltd.

(21) Appl. No.: 12/796,525

(22) Filed: Jun. 8, 2010

(30) Foreign Application Priority Data
Jun. 8, 2009 (CN) 200910147175.4

(51) Int. Cl. G06F 12/14; G06F 12/00; G06F 9/46

(52) U.S. Cl. 711/152; 711/147; 718/102; 711/167; 711/E12.001; 711/E12.093

(57) ABSTRACT

A method, an apparatus, and a system for enabling a processor to access shared data are provided to overcome low efficiency of a storage system. The method includes that the processor sends a storage block locking command to the storage system through a hardware thread, where the command instructs the storage system to lock a storage block; the processor judges whether a storage block locking completion message has been received from the storage system in a preset clock period; and, schedules the hardware thread to access shared data in the storage block if the storage block locking completion message has been received from the storage system in the preset clock period, or schedules the hardware thread to keep waiting for the storage block locking completion message from the storage system if no storage block locking completion message has been received from the storage system in the preset clock period.

### CROSS-REFERENCE TO RELATED APPLICATION

This application claims priority under 35 U.S.C. §119 to Chinese Patent Application No. 200910147175.4, filed on Jun. 8, 2009, which is hereby incorporated by reference in its entirety.

### TECHNICAL FIELD

The present invention relates to the computer field, and in particular, to a method, an apparatus and a system for enabling a processor to access shared data.

### BACKGROUND

Currently, the multi-processor system is booming. Multiple processors use a shared storage to process data, which is one of the main modes for a multi-processor system to process data. That is, multiple processors share a centralized storage. Currently, multiple processors share a storage primarily in a three-level storage structure. That is, each of the multiple processors has a private cache of a small capacity, multiple processors share a level-2 cache of a larger capacity, and the multiple processors share a mass physical storage. The multi-processor system of such a storage structure has a simple structure, provides a good performance-to-price ratio, and is applied widely.

However, when multiple processors access the shared data stored in the shared physical storage, if the read-write order of each of the multiple processors is not arranged properly, multiple processors may read and write the shared data included in the same storage area of the shared storage concurrently. Consequently, the read-write operation of one processor is interleaved with that of another processor, and no processor can access the shared data in the shared storage correctly.

In order to make each of multiple processors access the shared data in the shared storage exclusively, the conventional art provides the following two methods that enable multiple processors to access shared data:

(1) A bus lock technology is applied to make each of multiple processors access shared data exclusively. More specifically, before a processor accesses the shared data, the processor checks whether the bus is in an unlocked state; when the bus is in the unlocked state, a command is issued to lock the whole bus or the whole storage system so that no processor or bus device other than this processor can access the shared data in the storage system. In this way, the processor accesses the shared data exclusively.

Through this method, when multiple processors read or write the shared data concurrently, each processor can access the shared data exclusively. However, the whole communication bus or the whole storage system is locked, and only one processor uses the bus or the storage system. Consequently, other operations involving no access to the shared data are disabled, and the utilization ratio of the whole system is reduced.

(2) A software lock technology is applied to make each of multiple processors access shared data exclusively. The software lock is a shared variable. All processors contend for a fixed value (such as the fixed value is 0) of the variable through an atomic operation instruction provided by the system. The processor that obtains this value is entitled to exclusive access to the shared data.

Through this method, when multiple processors access shared data exclusively, the processors contend for the software lock to obtain the right of accessing shared data exclusively, without the need of locking the whole communication bus or the whole storage system, namely, without exclusive use of the whole communication bus or the whole storage system. In this way, other operations that involve no access to the shared data can go on normally, which improves the utilization ratio of the system to some extent. However, when each of multiple processors accesses the shared data exclusively through the software lock technology, all processors need to keep issuing commands of accessing the storage until a processor obtains the software lock. Consequently, the processors attempt to access the storage frequently and such access is mostly futile, and the storage system needs to keep processing the futile access, which leads to low efficiency of the storage system.

### SUMMARY

The embodiments of the present invention provide a method, an apparatus, and a system for enabling a processor to access shared data in order to improve the efficiency of the storage system.

To fulfill such an objective, the following technical solution is applied in the embodiments of the present invention:

A method for enabling a processor to access shared data includes:

sending a storage block locking command to a storage system through a hardware thread, where the command instructs the storage system to lock a storage block;

judging whether a storage block locking completion message has been received from the storage system in a preset clock period; and

scheduling the hardware thread to access shared data in the storage block if the storage block locking completion message has been received from the storage system in the preset clock period; or scheduling the hardware thread to keep waiting for the storage block locking completion message from the storage system if no storage block locking completion message has been received from the storage system in the preset clock period.

A processor includes:

a sending unit, configured to send a storage block locking command to a storage system through a hardware thread, where the command instructs the storage system to lock a storage block;

a judging unit, configured to judge whether a storage block locking completion message has been received from the storage system in a preset clock period; and

an executing unit, configured to: schedule the hardware thread to access shared data in the storage block if the judging unit determines that the storage block locking completion message has been received from the storage system in the preset clock period; or schedule the hardware thread to keep waiting for the storage block locking completion message from the storage system if the judging unit determines that no storage block locking completion message has been received from the storage system in the preset clock period.

A system for enabling a processor to access shared data includes a processor system and a storage system. The processor system is composed of at least one processor. The processor sends a storage block locking command to the storage system through a hardware thread, where the command instructs the storage system to lock a storage block. The processor judges whether a storage block locking completion message has been received from the storage system in a preset clock period; and schedules the hardware thread to access shared data in the storage block if the storage block locking completion message has been received from the storage system in the preset clock period, or schedules the hardware thread to keep waiting for the storage block locking completion message from the storage system if no storage block locking completion message has been received from the storage system in the preset clock period.

The storage system receives the storage block locking command sent by the processor, and sends the storage block locking completion message to the processor for instructing the processor to access the shared data in the locked storage block.

Through the technical solutions in accordance with the embodiments of the present invention, when the processor accesses the shared data, the processor sends to the storage system, through the hardware thread thereof, an instruction of locking the storage block that carries the shared data; after receiving the storage block locking completion message sent by the storage system, the processor schedules the hardware thread to access the shared data carried in the locked storage block. Therefore, when the processor obtains the right of accessing the shared data, the processor needs only to wait for the storage block locking completion message from the storage system, and does not need to keep sending requests for the shared data to the storage system; and the storage system does not need to process too much futile access, and the efficiency of the storage system is improved.

### BRIEF DESCRIPTION OF THE DRAWINGS

To illustrate the technical solution according to the embodiments of the present invention or in the prior art more clearly, the accompanying drawings for describing the embodiments or the prior art are given briefly below. Apparently, the accompanying drawings in the following description are only some embodiments of the present invention, and persons of ordinary skilled in the art can derive other drawings from the accompanying drawings without creative efforts.

FIG. 1 is a flowchart of a method for enabling a processor to access shared data in the first embodiment of the present invention;

FIG. 2 is a flowchart of a method for sharing data in a storage system in the first embodiment of the present invention;

FIG. 3 is a block diagram of a processor in the first embodiment and the second embodiment of the present invention;

FIG. 4 is a block diagram of a storage system in the first embodiment and the second embodiment of the present invention;

FIG. 5 is a block diagram of a system for enabling a processor to access shared data in the first embodiment of the present invention;

FIG. 6 is a flowchart of a method for enabling a processor to access shared data in the second embodiment of the present invention;

FIG. 7 is a flowchart of a method for sharing data in a storage system in the second embodiment of the present invention;

FIG. 8 is a block diagram of a system for enabling a processor to access shared data in the second embodiment of the present invention; and

FIG. 9 is an operation flowchart that illustrates how a processor accesses shared data in the third embodiment of the present invention.

### DETAILED DESCRIPTION

The following detailed description is directed to the technical solution in the embodiments of the present invention with reference to the accompanying drawings. However, the embodiments to be described are only a part of, rather than all of, the embodiments of the present invention. Additionally, all other embodiments, which can be derived by those skilled in the art from the embodiments given herein without any creative efforts, fall within the scope of the present invention.

### First Embodiment

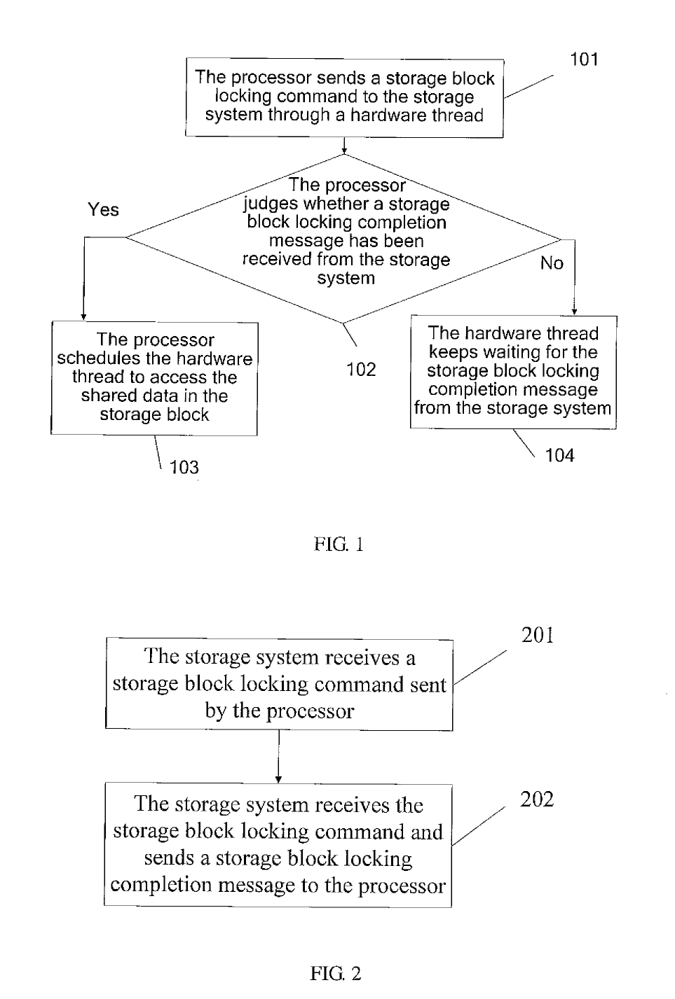

A method for enabling a processor to access shared data is provided in this embodiment. As shown in FIG. 1, the method includes the following steps:

101: The processor sends a storage block locking command to the storage system through a hardware thread, where the command instructs the storage system to lock a storage block so that the processor can access the shared data exclusively.

102: After the storage block locking command is sent to the storage system, the processor needs to judge whether a storage block locking completion message has been received from the storage system in the preset clock period. The preset clock period is an empiric value, and can be set according to the period of the storage system executing the instruction. If the processor has received the storage block locking completion message from the storage system within the preset clock period, the processor performs step 103, or else performs step 104.

103: If the processor has received a storage block locking completion message from the storage system within the preset clock period, which indicates that the processor obtains the right of accessing the storage block, the processor schedules the hardware thread to access shared data in the storage block.

104: if the processor has not received the storage block locking completion message from the storage system within the preset clock period, it indicates that the storage block desired by the processor has been locked by another processor, the storage system is unable to allocate the storage block to the requesting processor currently, and the requesting processor fails to obtain the right of accessing the data in the storage block. In this case, the hardware thread goes on waiting for the storage block locking completion message from the storage system until it receives such a message so that the processor can access the shared data in the storage block.

A method for sharing data in a storage system in this embodiment includes the following steps:

201: The storage system receives a storage block locking command sent by a processor. The storage block locking command is a software instruction. The processor sends the storage block locking command to the storage system explicitly.

202: The storage system executes the received storage block locking command, and detects the state of the storage block indicated in the received storage block locking command, where the state may be either a locked state or an unlocked state. If the storage block is in the unlocked state, the storage system locks the storage block, and sends a storage block locking completion message to the processor. The message instructs the processor to access the shared data carried in the locked storage block.

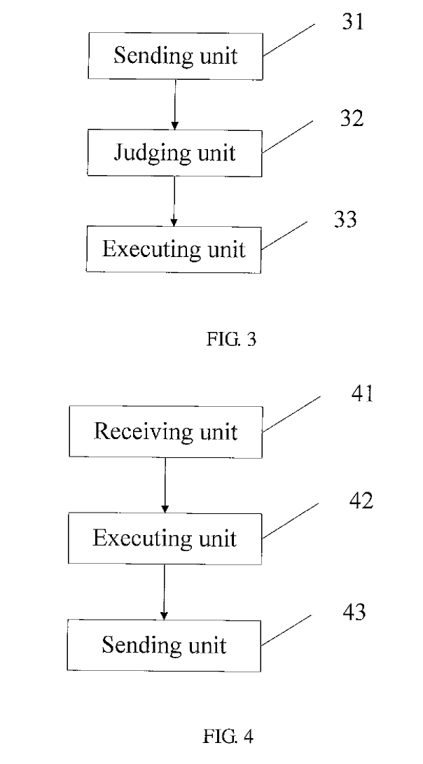

As shown in FIG. 3, a processor provided in this embodiment includes: a sending unit 31, a judging unit 32, and an executing unit 33.

The sending unit 31 is configured to send a storage block locking command to the storage system through a hardware thread, where the command instructs the storage system to lock a storage block so that the processor can access the shared data in the storage block exclusively.

After the processor sends the storage block locking command to the storage system through the sending unit 31, the processor uses the judging unit 32 to judge whether a storage block locking completion message has been received from the storage system in a preset clock period. The preset clock period is an empiric value and may be set according to the period of the storage system executing the instructions. The processor uses the executing unit 33 to schedule the hardware thread to access shared data in the storage block if the judging unit 32 determines that the processor has received the storage block locking completion message from the storage system in the preset clock period; or, the executing unit 33 schedules the hardware thread to keep waiting for the storage block locking completion message from the storage system if the judging unit 32 determines that the processor has not received the storage block locking completion message from the storage system in the preset clock period.

As shown in FIG. 4, a storage system provided in this embodiment includes: a receiving unit 41, an executing unit 42, and a sending unit 43.

The receiving unit 41 is configured to receive a storage block locking command sent by a processor, where the storage block locking command is a software instruction. After the storage system receives the storage block locking command, the executing unit 42 executes the received storage block locking command, and detects the state of the storage block indicated in the received storage block locking command, where the state may be either a locked state or an unlocked state. If the storage block is in the unlocked state, the storage system locks the storage block, and then the sending unit 43 sends a storage block locking completion message to the processor. The message instructs the processor to access the shared data carried in the storage block.

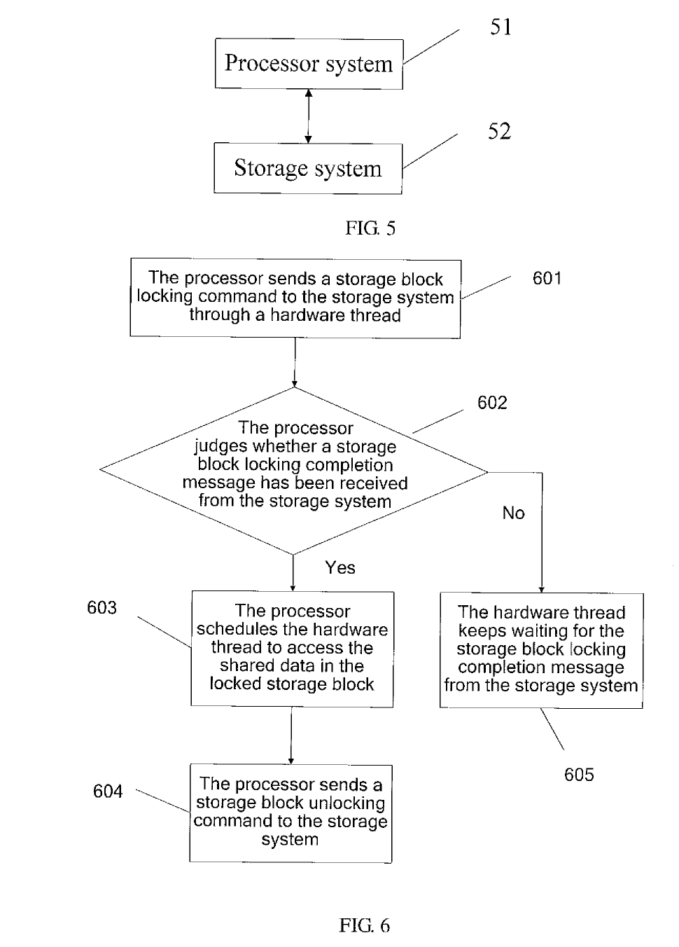

A system for enabling a processor to access shared data is provided in this embodiment. As shown in FIG. 5, the system includes a processor system 51 and a storage system 52. The processor system 51 is composed of at least one processor. The processor sends a storage block locking command to the storage system through a hardware thread, where the command instructs the storage system to lock a storage block. The processor judges whether a storage block locking completion message has been received from the storage system in a preset clock period; and schedules the hardware thread to access shared data in the storage block if the processor has received the storage block locking completion message from the storage system in the preset clock period, or schedules the hardware thread to keep waiting for the storage block locking completion message from the storage system if the processor has not received the storage block locking completion message from the storage system in the preset clock period.

The storage system 52 is configured to: receive the storage block locking command sent by the processor, and send the storage block locking completion message to the processor to instruct the processor to access the shared data in the storage block.

In this embodiment, when the processor accesses the shared data, the processor sends through the hardware thread thereof to the storage system a command of locking the storage block that carries the shared data; after receiving the storage block locking completion message sent by the storage system, the processor schedules the hardware thread to access the shared data carried in the storage block. Therefore, when the processor obtains the right of accessing the shared data, the processor needs only to wait for the storage block locking completion message from the storage system, and does not need to keep sending requests for the shared data to the storage system; and the storage system does not need to process too much futile access, and the efficiency of the storage system is improved.

### Second Embodiment

A method for enabling a processor to access shared data is provided in this embodiment. As shown in FIG. 6, the method includes the following steps:

601: The processor sends a storage block locking command to the storage system through a hardware thread, where the command instructs the storage system to lock a storage block so that the processor can access the shared data exclusively.

The storage block locking command is a software instruction. The software instruction carries an instruction header of the locking command, head address of the storage block to be locked, and size of the storage block to be locked. The command may be extracted as “LockMem BlockBase, BlockSize”. In this command, “LockMem” is an instruction header of the storage block locking command, and requires the storage system to lock a specified storage block, namely, allow only the processor that sends the locking command to access the storage block; “BlockBase” indicates the head address of the storage block to be locked; and “BlockSize” indicates size of the storage block to be locked. In order to improve the efficiency of the storage system hardware processing the command, “BlockBase” and “BlockSize” are generally multiples of an integer-order power of 2.

Further, in order to improve the hardware processing efficiency of the storage system, the “BlockSize” parameter that indicates the size of the storage block is set to a fixed value which serves as a default value. In this way, the software command of the storage block locking command carries the instruction header of the locking command and the head address of the storage block to be locked, and the command may be extracted as LockMem BlockBase. The head address of the storage block to be locked is generally aligned with the line of the cache in the storage system.

602: After the processor sends the storage block locking command to the storage system through the hardware thread, the processor needs to judge whether a storage block locking completion message has been received from the storage system in the preset clock period. The preset clock period is an empiric value, and can be set according to the period of the storage system executing the instruction. If the processor has received the storage block locking completion message from the storage system within the preset clock period, the processor performs step 603, or else performs step 605.

603: If the processor has received the storage block locking completion message from the storage system within the preset clock period, which indicates that the processor obtains the right of accessing the storage block, the processor uses its scheduler to schedule the hardware thread to access shared data in the storage block.

604: After completion of accessing the shared data in the storage block, the processor sends a storage block unlocking command to the storage system. The command instructs the storage system to unlock the storage block so that the storage block is accessible to other processors or devices.

The storage block unlocking command sent by the processor is a software instruction, which carries an instruction header of the unlocking command and the head address of the storage block to be unlocked. The command may be abstracted as UnlockMem BlockBase.

In the foregoing command, UnlockMem is an instruction header of the unlocking command, and instructs the storage system to unlock the storage block, and BlockBase is the head address of the storage block to be unlocked.

605: If the processor has not received the storage block locking completion message from the storage system within the preset clock period, it indicates that the storage block desired by the processor is locked by another processor, the storage system is currently unable to allocate the storage block to the requesting processor, and the requesting processor is not entitled to access the shared data in the storage block. In this case, the storage system has to wait for release of the storage block. That is, unless the storage block returns to the unlocked state can the storage system lock the storage block again, and can the processor obtain the right of accessing the storage block. The following practice prevents impact on other processing operations of the processor: If the processor has not received the storage block locking completion message within the preset clock period, the hardware thread of the processor that sends the storage block locking command keeps waiting for the storage block locking completion message from the storage system until it receives the locking completion message.

A method for sharing data in a storage system is provided in this embodiment. As shown in FIG. 7, the method includes the following steps:

701: The storage system receives a storage block locking command sent by a processor. The storage block locking command is a software instruction. The processor sends the storage block locking command to the storage system explicitly.

702: The storage system executes the received storage block locking command, and detects the state of the storage block indicated in the received storage block locking command, where the state may be either a locked state or an unlocked state. If the storage block is in the unlocked state, the storage system locks the storage block, and performs step 703. After the storage system locks the storage block, it is illegal for other processors to access the shared data in the locked storage block, and only the processor that sends the storage block locking command can access the shared data in the storage block normally. In this way, the processor can access the shared data exclusively.

In this step, when the storage block is in the locked state, unless the storage block becomes unlocked can the storage system allocate the storage block to the processor via locking the storage block for the processor and send the storage block locking completion message to the processor. The storage block locking completion message instructs the processor to access the shared data in the storage block.

703: After locking the storage block, the storage system sends a storage block locking completion message to the processor, instructing the processor to access the shared data in the locked storage block.

704: After completion of accessing the shared data, the processor sends a storage block unlocking command to the storage system, instructing the storage system to unlock the storage block. The storage system receives the storage block unlocking command sent by the hardware thread of the processor.

705: The storage system unlocks the storage block according to the unlocking command so that the shared data in the storage block is accessible to other processors and bus devices.

As shown in FIG. 3, a processor provided in this embodiment includes: a sending unit 31, a judging unit 32, and an executing unit 33.

The sending unit 31 is configured to send a storage block locking command to the storage system through a hardware thread in the processor, where the command instructs the storage system to lock the storage block. The storage block locking command is a software instruction, which carries an instruction header of the locking command, a head address of the storage block to be locked, and size of the storage block to be locked. In order to improve the efficiency of processing the command by the storage system hardware, the “BlockSize” parameter that indicates the size of the storage block to be locked is set to a fixed value which serves as a default value.

After the sending unit 31 sends the storage block locking command to the storage system, the processor uses the judging unit 32 to judge whether a storage block locking completion message has been received from the storage system in the preset clock period. The preset clock period is an empiric value, and can be set according to the period of executing the locking command by the storage system.

If the judging unit 32 determines that the processor has received the storage block locking completion message from the storage system in the preset clock period, the executing unit 33 schedules the hardware thread to access the shared data in the storage block. If the judging unit 32 determines that the processor has not received the storage block locking completion message from the storage system in the preset clock period, the executing unit 33 schedules the hardware thread to keep waiting for the storage block locking completion message from the storage system, and invokes the judging unit 32 to further check whether a storage block locking completion message has been received from the storage system until the judging unit 32 detects that the processor has received the storage block locking completion message from the storage system, whereupon the executing unit 33 schedules the hardware thread to access the shared data in the storage block.

After the processor finishes accessing the shared data in the storage block, the sending unit 31 sends a storage block unlocking command to the storage system. The command instructs the storage system to unlock the storage block. The storage block unlocking command is a software instruction.

As shown in FIG. 4, a storage system provided in this embodiment includes: a receiving unit 41, an executing unit 42, and sending unit 43.

The receiving unit 41 is configured to receive a storage block locking command from the processor. The storage block locking command is a software instruction. After the storage system receives the storage block locking command, the executing unit 42 executes the received storage block locking command, and detects the state of the storage block indicated in the received storage block locking command, where the state may be either a locked state or an unlocked state. If the storage system detects that the storage block to be locked is in the unlocked state, the storage system locks the storage block, and then the sending unit 43 sends a storage block locking completion message to the processor. The message instructs the processor to access the shared data carried in the locked storage block.

After the processor sends a storage block unlocking command to the storage system, the receiving unit 41 receives the storage unlocking command from the processor. After receiving the unlocking command, the storage system uses the executing unit 42 to unlock the storage block so that the shared data in the storage block is accessible to other processors or bus devices.

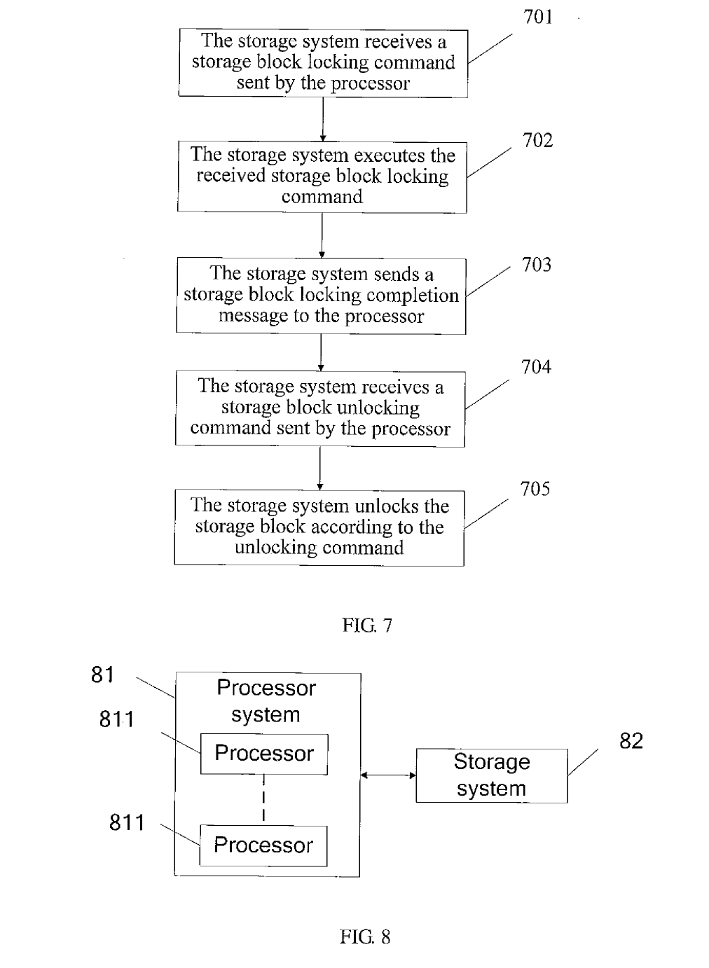

A system for enabling a processor to access shared data is provided in this embodiment. As shown in FIG. 8, the system includes a processor system 81 and a storage system 82. The processor system 81 is composed of at least one processor 811.

The processor 811 sends a storage block locking command to the storage system 82 through a hardware thread, where the command instructs the storage system to lock a storage block. After the storage block locking command is sent, the processor judges whether a storage block locking completion message has been received from the storage system in a preset clock period; and schedules the hardware thread to access shared data in the storage block if the processor has received the storage block locking completion message from the storage system in the preset clock period, or schedules the hardware thread to keep waiting for the storage block locking completion message from the storage system if the processor has not received the storage block locking completion message from the storage system in the preset clock period.

After completion of accessing the shared data in the storage block in the case that the processor 811 receives the storage block locking completion message from the storage system 82 in the preset clock period, the processor 811 sends a storage block unlocking command to the storage system through the hardware thread thereof to instruct the storage system 82 to unlock the storage block.

After the processor 811 sends the storage block locking command to the storage system through the hardware thread, the storage system 82 is configured to receive and execute the storage block locking command sent by the processor. After locking the storage block successfully, the storage system 82 sends a storage block locking completion message to the processor to instruct the processor to access the data stored in the storage block.

After the processor 811 sends the storage block unlocking command to the storage system 82 through the hardware thread, the storage system 82 is further configured to receive and execute the storage block unlocking command sent by the processor so that the shared data stored in the storage block is accessible to other processors or bus devices.

In this embodiment, when the processor accesses the shared data, the processor sends through the hardware thread thereof to the storage system an instruction of locking the storage block that carries the shared data; after receiving the storage block locking completion message sent by the storage system, the processor schedules the hardware thread to access the shared data carried in the locked storage block. Therefore, when the processor obtains the right of accessing the shared data, the processor needs only to wait for the storage block locking completion message from the storage system, and does not need to keep sending requests for the shared data to the storage system; and the storage system does not need to process too much futile access, and the efficiency of the storage system is improved.

Moreover, when the processor has not received the storage block locking completion message from the storage system within the preset clock period, the processor lets the hardware thread that sends the storage block locking command keep waiting for the storage block locking completion message from the storage system, and the processor switches other functions of the processor over to other threads of the processor. In this way, the processor that fails to obtain the right of accessing the shared data within the preset clock period does not need to wait for the right futilely, and the utilization ratio of the whole system is improved.

Further, when the storage system executes the storage block locking command sent by the processor, if the storage block to be locked is in the locked state, the storage system suspends the request for accessing the shared data automatically, and does not process the request in any way before the storage block to be locked changes from the locked state to the unlocked state. In this way, the clock period of the storage system is saved to some extent, the storage system leaves more time of the clock period for performing other operations, and the utilization ratio of the whole system is improved.

### Third Embodiment

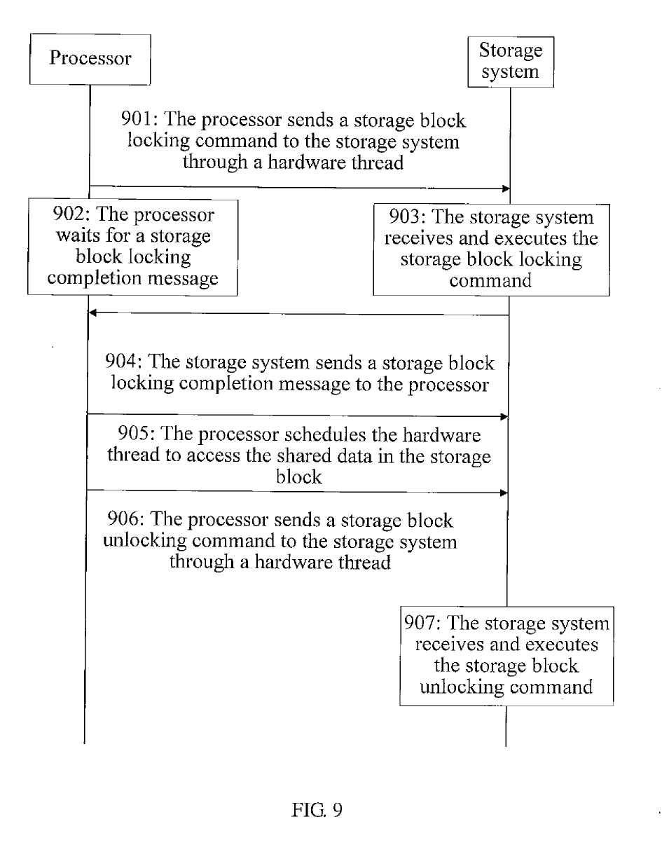

A method for enabling a processor to access shared data is provided in this embodiment. As shown in FIG. 9, the method includes the following steps:

901: The processor sends a storage block locking command to the storage system through a hardware thread, where the storage block locking command is a software instruction.

902: After sending the storage block locking command to the storage system, the processor waits for a storage block locking completion message. The waiting process is: The processor keeps checking whether a storage block locking completion message is received from the storage system in a preset clock period.

903: The storage system receives and executes the storage block locking command sent by the processor. The storage system executes the storage block locking command in this way: The storage system detects the state of the storage block, where the state is either a locked state or an unlocked state; if the storage block to be locked is in the unlocked state, the storage system locks the storage block, and performs step 904; if the storage block is in the locked state, the storage system suspends the locking request sent by the processor until the storage block becomes unlocked. After the storage block becomes unlocked, the storage system executes the locking request sent by the processor.

904: The storage system sends a storage block locking completion message to the processor, indicating that the processor is entitled to access the shared data in the storage block.

905: After receiving the storage block locking completion message from the storage system, the processor uses its scheduler to schedule the hardware thread to access the shared data in the storage block.

906: After completion of accessing the shared data in the locked storage block, the processor sends a storage block unlocking command to the storage system through the hardware thread. The storage block unlocking command is a software instruction.

907: The storage system receives and executes the storage block unlocking command sent by the processor, whereupon the shared data in the storage block is accessible to other processors or bus devices.

In this embodiment, when the processor obtains the right of accessing the shared data, the processor needs only to wait for the storage block locking completion message from the storage system, and does not need to keep sending requests for the shared data to the storage system; and the storage system does not need to process too much futile access, and the efficiency of the storage system is improved. Moreover, when the processor has not received the storage block locking completion message from the storage system within the preset clock period, the processor lets the hardware thread that sends the storage block locking command keep waiting for the storage block locking completion message from the storage system, and the processor switches other functions of the processor over to other threads of the processor. In this way, the processor that fails to obtain the right of accessing the shared data within the preset clock period does not need to wait for the right futilely, and the utilization ratio of the whole system is improved.

Further, when the storage system executes the storage block locking command sent by the processor, if the storage block to be locked is in the locked state, the storage system suspends the request for accessing the shared data automatically, and does not process the request in any way before the storage block to be locked changes from the locked state to the unlocked state. In this way, the clock period of the storage system is saved to some extent, the storage system leaves more time of the clock period for performing other operations, and the utilization ratio of the whole system is improved.

After reading the foregoing embodiments, those skilled in the art are clearly aware that the embodiments of the present invention may be implemented through hardware, or through software in addition to a necessary universal hardware platform, but the latter is preferred in most circumstances. Therefore, the technical solution under the present invention or its novelty in contrast to the prior art may be embodied in a software product. The software product is stored in a computer-readable storage medium such as computer floppy disk, hard disk and CD-ROM, and incorporates several instructions for instructing a computer device (for example, personal computer, server, or network device) to execute the method specified in each embodiment of the present invention.

The above descriptions are merely preferred embodiments of the present invention, but not intended to limit the scope of the present invention. Any modifications, variations, or replacement that can be easily derived by those skilled in the art should fall within the scope of the present invention. Therefore, the protection scope of the present invention is subject to the appended claims.

What is claimed is:

1. A method for enabling a processor to access shared data, the method comprising:
sending a storage block locking command to a storage system through a hardware thread, wherein the command instructs the storage system to lock a storage block;
judging whether a storage block locking completion message has been received from the storage system in a preset clock period; and
scheduling the hardware thread to access shared data in the storage block if the storage block locking completion message has been received from the storage system in the preset clock period; or
scheduling the hardware thread to keep waiting for the storage block locking completion message from the storage system if no storage block locking completion message has been received from the storage system in the preset clock period.

2. The method for enabling a processor to access shared data according to claim 1, wherein after scheduling the hardware thread to access the shared data in the storage block, the method further comprises:
sending a storage block unlocking command to the storage system through the hardware thread, wherein the command instructs the storage system to unlock the storage block.

3. The method for enabling a processor to access shared data according to claim 2, wherein:
the storage block unlocking command is a software instruction, which carries an instruction header of the unlocking command and a head address of the storage block to be unlocked.

4. The method for enabling a processor to access shared data according to claim 1, wherein:
the storage block locking command is a software instruction, which carries an instruction header of the locking command, a head address of the storage block to be locked, and size of the storage block to be locked.

5. The method for enabling a processor to access shared data according to claim 1, wherein:
when a size of the storage block to be locked is fixed, the storage block locking command carries an instruction header of the locking command and a head address of the storage block to be locked.

6. A processor, comprising:
a sending unit, configured to send a storage block locking command to a storage system through a hardware thread, wherein the command instructs the storage system to lock a storage block;
a judging unit, configured to judge whether a storage block locking completion message has been received from the storage system in a preset clock period; and
an executing unit, configured to: schedule the hardware thread to access shared data in the storage block if the judging unit determines that the storage block locking completion message has been received from the storage system in the preset clock period; or schedule the hardware thread to keep waiting for the storage block locking completion message from the storage system if the judging unit determines that no storage block locking completion message has been received from the storage system in the preset clock period.

7. The processor of claim 6, wherein the sending unit is further configured to:
schedule the hardware thread to send a storage block unlocking command to the storage system after scheduling the hardware thread to access the shared data in the storage block, wherein the storage block unlocking command instructs the storage system to unlock the storage block.

8. A system for enabling a processor to access shared data, the system comprising a processor system and a storage system, wherein:
the processor system comprises at least one processor; the processor sends a storage block locking command to the storage system through a hardware thread, wherein the command instructs the storage system to lock a storage block; and the processor judges whether a storage block locking completion message has been received from the storage system in a preset clock period, and schedules the hardware thread to access shared data in the storage block if the processor has received the storage block locking completion message from the storage system in the preset clock period, or schedules the hardware thread to keep waiting for the storage block locking completion message from the storage system if the processor has not received the storage block locking completion message from the storage system in the preset clock period; and
the storage system receives the storage block locking command sent by the processor, and sends the storage block locking completion message to the processor, instructing the processor to access the shared data carried in the locked storage block.
